(19) United States
(12) Patent Application Publication
(10) Pub. No.: US 2010/0257718 A1
(43) Pub. Date: Oct. 14, 2010

(54) Modular Structure Alignment Apparatus and Method of Aligning Modules

(76) Inventors: Richard Gartin, Kearney, MO (US); Barry Scoma, Kansas City, MO (US); Teresa Lawver, Kansas City, KS (US)

Correspondence Address: POLSINELLI SHUGHART PC, 700 W. 47TH STREET, SUITE 1000, KANSAS CITY, MO, 64112-1802, US

(21) Appl. No.: 12/420,117

(22) Filed: Apr. 8, 2009

(51) Int. Cl. B23Q 3/00

(52) U.S. Cl. 29/464; 29/281.5

(57) ABSTRACT

The present invention relates to an alignment apparatus for use in the construction of modular or prefabricated structures and a method for aligning the individual modules using the alignment apparatus. The apparatus is comprised of a first plate that has at least one pin positioned axially through the first plate, and an optional second plate having a pin-receiving hole. The modules are aligned by fastening the first plate to a first module and drilling a hole in the first and second modules to receive the pin. The modules are then joined together and are aligned by sliding the pin into the holes of the modules.

### FIELD OF INVENTION

The present invention relates to an alignment apparatus for use in the construction of modular or prefabricated structures. A method for aligning the modules using the apparatus is also disclosed.

### BACKGROUND OF INVENTION

The construction industry has attempted to provide simple economical building systems that can be used to construct stable, habitable structures in the shortest possible time using the least possible amount of resources, including construction materials and labor, while also attempting to provide the systems with as much freedom of design as possible. One such known building system is the modular building system, which includes separate, deconstructed modules that are connected together at a construction site to form a desired structure. The modules are prefabricated off-site in a factory and then transported to the construction site on trucks where the modules are positioned, aligned and connected together to form the finished structure.

Once a module arrives at the site, it must be aligned and connected to other modules to form the structure. It is important for the modules to be aligned in order to provide proper leveling of the roof and the floor, which in turn provides good overall structural support to the building. Current practices for aligning and connecting the modules do not involve the use of a standard apparatus or tool; rather, many different items and procedures are employed to align the modules, which tools and procedures are not specifically directed to aligning the modules. For example, it is currently known in the art to use a variety of items, such as screws, come-alongs, jacks, lags, or bolts, to align and connect the modules.

During transport of the modules to the construction site, it is quite common for the modules to twist or “rack.” One disadvantage of the current alignment practices is that it is more time-consuming to level and align the “racked” modules as opposed to modules that are not “racked.” In addition, use of come-alongs and lags to align the modules can place extreme pressure on the floor and roof of the structure, which could cause breakage to the structure. Come-alongs and lags can also create holes in the modular structures, such as in the roof, which require patching or additional maintenance over time to prevent water damage to the finished structure. With current practices and methods, alignment and connection of a single modular structure may take multiple workers an entire work day or longer to complete the task and, because the current methods are not specifically directed to providing proper alignment and connection of a structure, there is no assurance that the procedures employed will hold long-term.

In view of the foregoing, it would be desirable to provide an apparatus that: 1) quickly and easily maintains proper alignment of modules, thereby eliminating the risk of leaks and damage to the finished structure; 2) provides for a cosmetically finished look; and 3) conserves resources, both time and money, during the positioning, alignment, and connection process for the set-up of modular structures.

### SUMMARY OF THE INVENTION

The present invention specifically addresses and alleviates the above-referenced deficiencies associated with the construction of modular or prefabricated structures. The present invention is directed to an apparatus that can be attached to modules prior to aligning the modules to form a finished structure. The apparatus is designed to enable quick and easy achievement of proper alignment of modules at a construction site when the modules are connected to form a finished structure.

The alignment apparatus includes a first plate that has a front face, a back face, and an edge. The first plate has at least one pin, which is positioned axially through the first plate such that it is perpendicular to the front face and the back face, and at least one fastener hole for receiving a fastening member. The alignment apparatus may further include a second plate, which has a front face, a back face, and an edge. The second plate includes a pin-receiving hole and at least one fastener hole for receiving a fastening member.

A method for aligning modular structures is also disclosed herein. The method for aligning modular structures includes fastening the first plate to a first module by inserting a fastening apparatus through at least one fastening hole and inserting the pin of the first plate into at least one hole drilled into the first module. The first module, having the apparatus attached thereto, can then be connected to and aligned with a second module by moving the first module and the second module together and aligning the pin of the first plate with a corresponding hole drilled into the second module to receive the pin.

The method for using the alignment apparatus can also include fastening a first plate a first module and fastening a second plate to a second module. The first plate is fastened to a first module by inserting a fastening member through at least one fastening hole of the first plate and the second plate is fastened to a second module by inserting a fastening member through at least one fastening hole of the second plate. A hole is drilled into the first and second modules to receive the pin and the pin-receiving hole of the second plate surrounds the hole drilled into the second module. The first and second modules are then joined together by moving the modules towards each other and aligning the pin of the first plate with the pin-receiving hole of the second plate.

The present invention is advantageous because it provides for secure and accurate alignment of modules in less time and for less expense than current alignment methods known in the art.

### BRIEF DESCRIPTION OF THE DRAWINGS

FIG. 1 is a perspective top view of the first plate including pin.

FIG. 2 is a perspective side view of the first plate including pin.

FIG. 3 is a top view of the first plate including pin.

FIG. 4 is a perspective rear view of the first plate including pin.

FIG. 5 is a top view of the first plate without pin.

FIG. 6 is a top view of the second plate.

FIG. 7 is a rear view the second plate.

FIG. 8 is a side view of a module illustrating the first plate attached thereto.

FIG. 9 is a perspective view of the first plate and the second plate attached to a module.

### DETAILED DESCRIPTION OF THE PREFERRED EMBODIMENT

The present invention relates to an alignment apparatus 10 for use in the construction of modular and prefabricated structures. It is contemplated that the apparatus 10 described herein may be used by anyone skilled or trained in the art of constructing, including positioning, aligning, and connecting, modular and prefabricated structures on site.

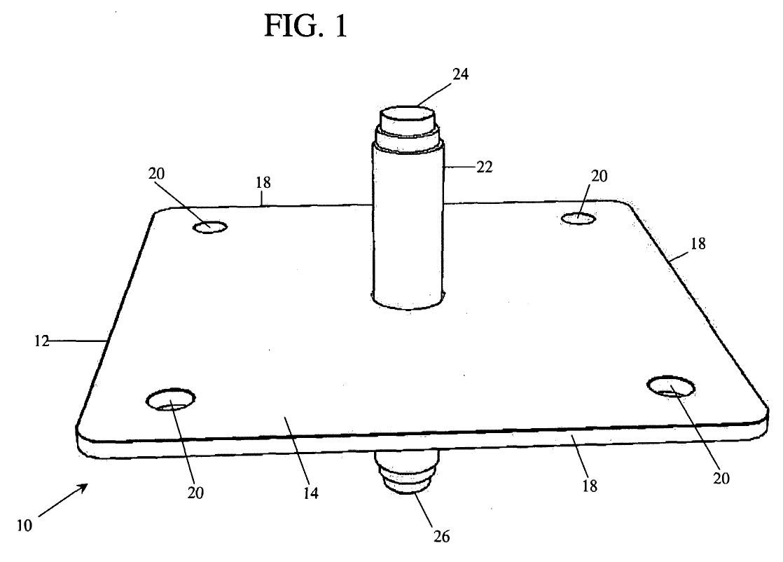

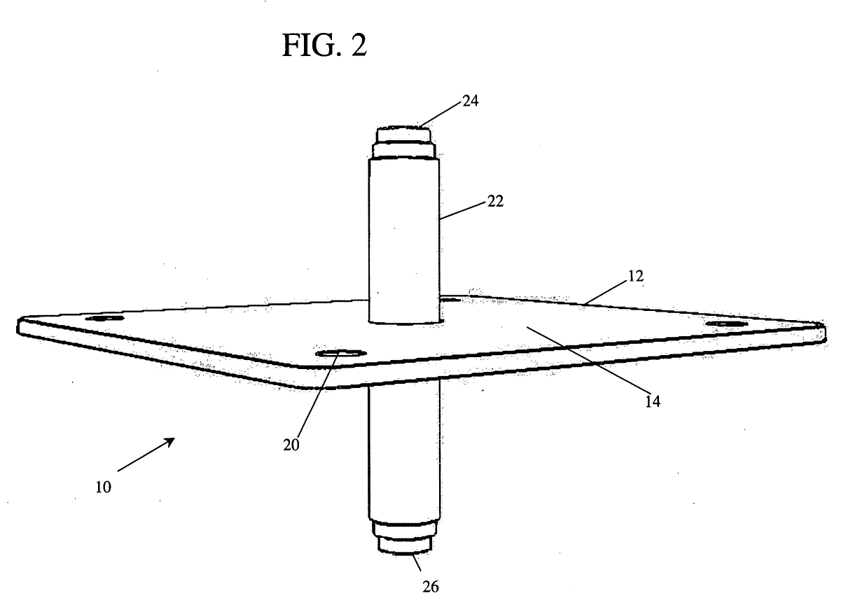

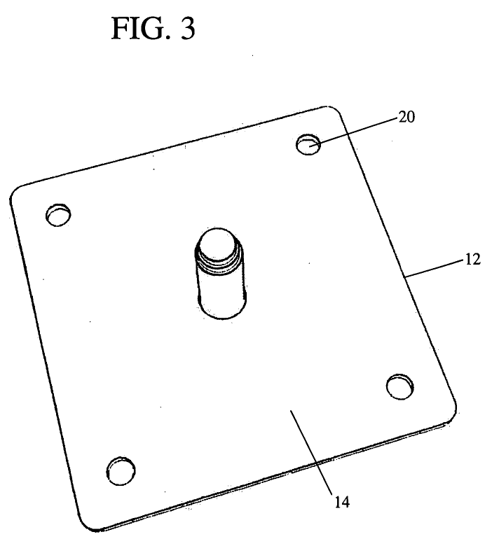

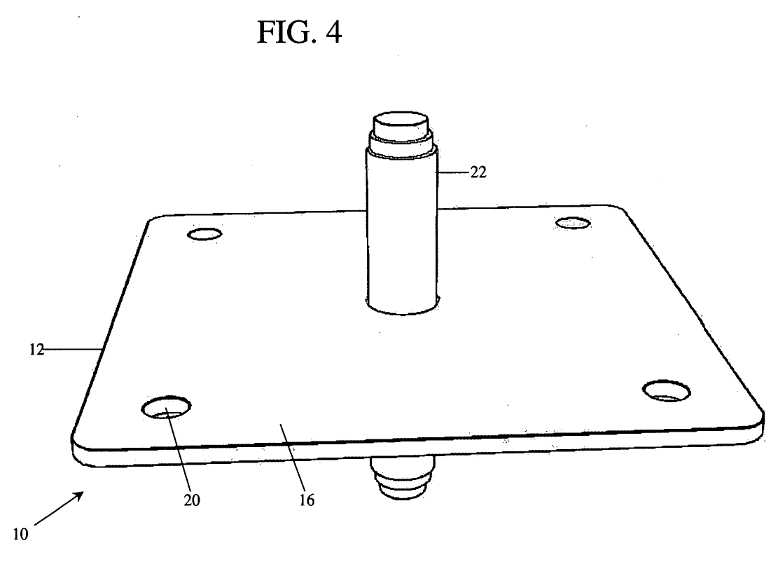

As illustrated in FIGS. 1-5, the apparatus 10 is comprised of a first plate 12, which includes a front face 14, a back face 16, and at least one edge 18. The first plate 12 can be of a variety of sizes and dimensions. The first plate 12 may be a square shape having dimensions ranging from 3 inches by 3 inches to 10 inches by 10 inches, and preferably having dimensions of 8 inches by 8 inches. Dependent on the size of the modules, other possible shapes and sizes of the first plate 12 may be, for example, rectangular, circular, oval, or triangular shaped. The first plate 12 can be any of a variety of thicknesses; however, it should be sufficiently thin to allow the apparatus 10 to be concealed from view when the modular structure is completed. Preferably, the thickness of the first plate is ¼ inch. The first plate 12 can be made from a variety of materials known in the industry, including, but not limited to, stainless steel, steel, aluminum, or combinations thereof. Preferably, the material is steel. The apparatus 10 is composed of material that is sturdy, can withstand the weight of the structure, and can properly and securely align the modules.

The first plate 12 may further include at least one fastener hole 20 for receiving a fastening member, as illustrated in FIGS. 1-5. The fastener hole allows a user to fixedly secure the first plate 12 to a module. Preferably, the first plate 12 includes four fastener holes as illustrated in FIGS. 1, 3, and 4. The fastener hole or holes 20 may be placed anywhere on the first plate 12 to enable attachment to a module. The fastening member may include a variety of different fasteners known in the industry, including, but not limited to, lags, lugs, or combinations thereof.

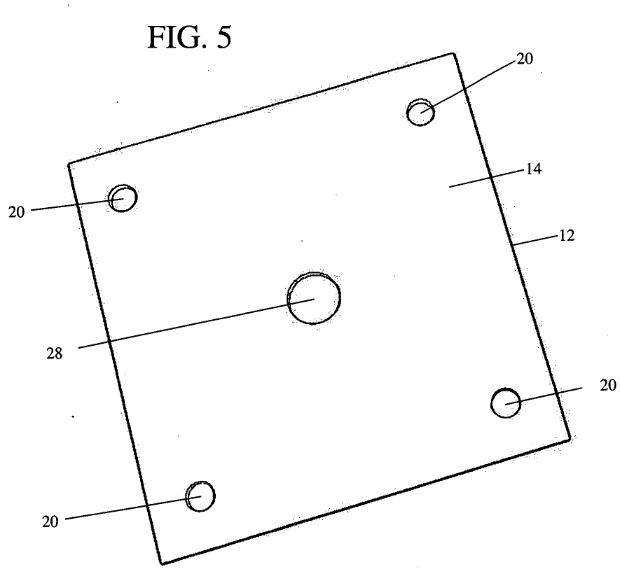

A pin 22 is attached to the first plate 12, as shown in FIGS. 1-4, to form the apparatus 10. The pin 22 may be integrally or removeably attached to the first plate 12 through a pin receiving hole 28 on the first plate 12, shown in FIG. 5, and is positioned axially through the first plate such that it is perpendicular to the front face 14 and the back face 16 of the first plate 12. In an alternative embodiment, a pin 22 is attached to the front face 14 of the first plate 12, and a pin 22 is attached to the back face 16 of the first plate 12. Each pin 22 is attached such that it is perpendicular to both the front face 14 and back face 16. The pin 22 can be of a variety of shapes and dimensions. Preferably, the pin 22 is a cylindrical member having a pair of opposed ends 24, 26. The length of the pin may range from about 2 inches and about 8 inches. Preferably, the length of the pin is 8 inches. The diameter of the pin 22 may range from about 0.5 inches to about 1.5 inches, and is preferably 1 inch.

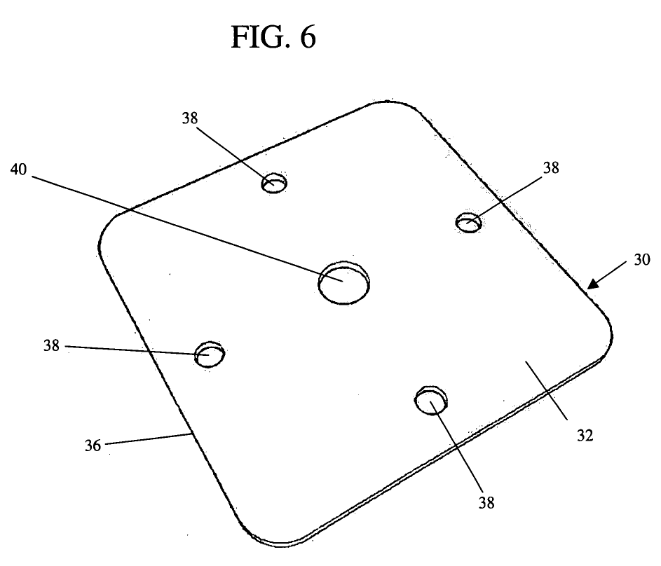

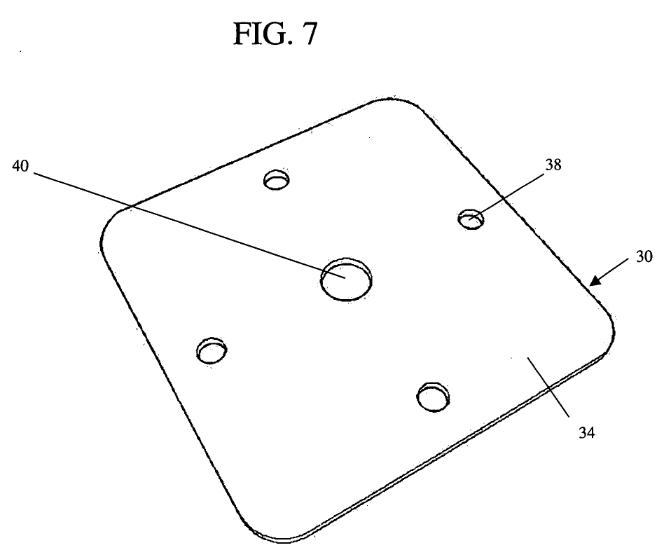

In an alternative embodiment, the apparatus 10 may include a second plate 30, as illustrated in FIGS. 6 and 7. The second plate 30 includes a front face 32, a back face 34, and at least one edge 36. The second plate 30 can be of a variety of sizes and dimensions. The second plate 30 may be a square shape having dimensions ranging from 3 inches by 3 inches to 10 inches by 10 inches, and preferably having dimensions of 8 inches by 8 inches. Dependent on the size of the modular unit, other shapes and sizes of the second plate 30 may be, for example, rectangular, circular, oval, or triangular. The second plate 30 can be any of a variety of thicknesses; however, it should be sufficiently thin to allow the apparatus 10 to be concealed from view when the modular structure is completed. Preferably, the thickness of the second plate is ¼ inch. The second plate 30 can be made from a variety of materials known in the industry, including, but not limited to, steel, aluminum, stainless steel, or combinations thereof. Preferably, the material of the second plate 30 is steel. The second plate 30 is composed of material that is sturdy, can withstand the weight of the structure, and can properly and securely align the modules.

As illustrated in FIGS. 6 and 7, the second plate 30 may further include at least one fastener hole 38 for receiving a fastening member. The fastener hole 38 allows a user to fixedly secure the second plate 30 to a module. Preferably, the second plate 30 includes four fastener holes 38 as illustrated in FIGS. 6 and 7. The fastener hole or holes 38 may be placed anywhere on the second plate 30 to enable attachment to a module. The fastening member may be a variety of different fasteners known in the industry, including, but not limited to, lags, lugs, or combinations thereof. Preferably, the second plate 30 contains the same number of fastener holes 38 as the first plate 12.

FIGS. 6 and 7 further illustrate that the second plate 30 additionally includes a pin-receiving hole 40 for receiving the pin 22 of the first plate 12. The diameter of the pin-receiving hole 40 will match that of the diameter of the pin 22 and preferably ranges from about 1 inch to about 1⅛ inches.

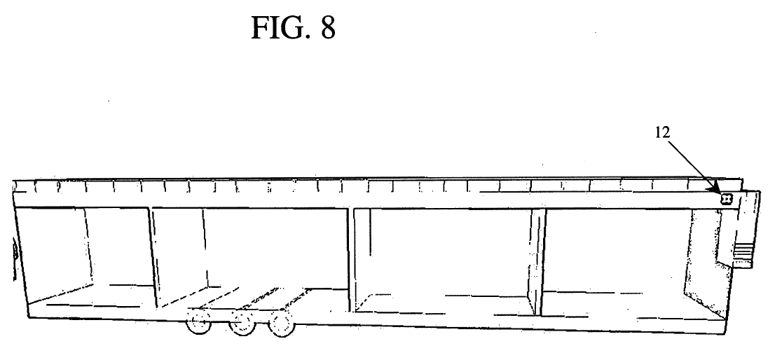

FIGS. 8 illustrates how the alignment apparatus 10 is used to align the modules of a modular structure. To align modules using the alignment apparatus 10, the first plate 12 is securely attached to a first module by fastening the first plate 12 thereto. The first plate 12 may be fastened anywhere on the first module. Preferably the first plate 12 is fastened on the header beam of the first module. A hole having the same diameter as the pin 22 of the first plate 12 is drilled into the header 42 of the first module, preferably at the front end of the header 42 and at a point that is vertically centered on the header 42. In an alternative embodiment, the first plate 12 can be attached anywhere along the header of the module. In a preferred embodiment of the method, an additional hole or holes may be drilled into the header 42 of the first module to correspond to the number of fastener holes 20 of the first plate 12. A fastener member or members are then inserted into the fastener holes 20 and the pin 22, which extends axially from the first plate 12, is received by the hole to properly secure the first plate 12 to the first module. A corresponding center hole is drilled into the header beam of the second module 44 in order to receive the pin 22 extending from the opposing face of the first plate 12. In order to align the two modules, the first and second modules are then joined together and the pin 22 of the first plate 12 is aligned with and received by the center hole drilled into the second module.

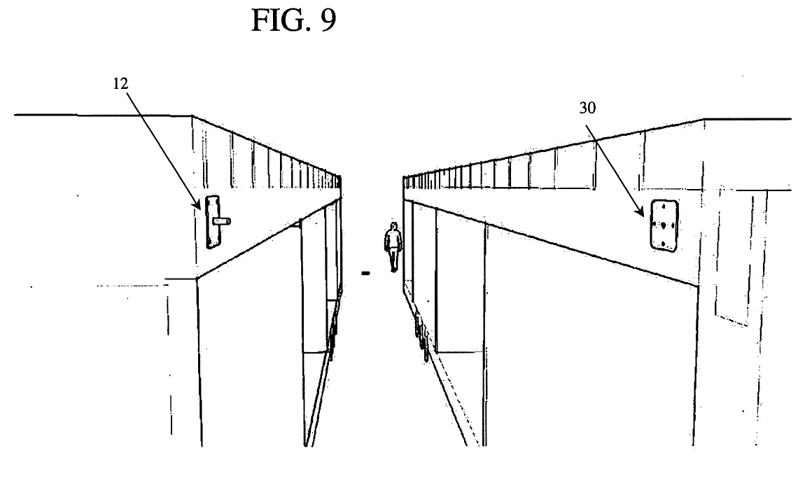

In an alternative embodiment, as depicted in FIG. 9, a second plate 30 is fastened to the second module such that the pin-receiving hole 40 surrounds the corresponding hole drilled into the second module to receive the pin 22 of the first plate 12. An additional hole or holes may be drilled into the second unit corresponding to the number of fastener holes 38 on the second plate 30. A fastener member or members are then inserted into the fastener holes 38 of the second plate 30 to attach the second plate to the header beam 44 of the second module. In order to align the two modules, the first and second modules are then joined together and the pin 22 of the first plate 12 is aligned with and received by the pin-receiving hole 40 of the second plate 30.

In an alternative embodiment, any number of alignment apparatuses 10 may be used to achieve proper alignment of the modules. As a non-limiting example, one apparatus may be fastened on the right end of the header beam, one apparatus may be fastened in the middle of the header beam, and one apparatus may be fastened on the left end of the header beam.

Thus, there has been shown and described an alignment apparatus that fulfills all objects and advantages sought therefore. The invention illustratively disclosed herein suitably may be practiced in the absence of any element that is not specifically disclosed herein. It is apparent to those skilled in the art, however, that many changes, variations, modification, other uses, and applications to the alignment apparatus are possible, and also such changes, variations, modifications, other uses, and application which do not depart from the spirit and scope of the invention are deemed to be covered by the invention, which is limited only by the claims which follow.

### DEFINITIONS

“Modular building” for purposes of the present invention refers to a system of building construction where individual sections of the building are manufactured off-site in factories then transported to the final building site. Minor finish work is completed and the building sections are connected to the ground and utilities. Modular buildings range in size from single sections to hundred unit complexes and can utilize temporary or permanent foundation systems. Also referred to as “prefabricated buildings.”

“Module” refers to a single three-dimensional section unit of a modular structure and is typically the largest unit to be transported to the final building site.

“Header” refers to a horizontal joist or beam that runs the length of a modular structure at the top of the structure, which supports the roof load and helps stabilize the structure during transport.

What is claimed is:

1. An alignment apparatus for a modular or prefabricated structure comprising:
i. a first plate having a front face, a back face, and an edge, wherein the first plate includes at least one fastener hole for receiving a fastening member and;
ii. at least one pin positioned axially through the first plate such that it is perpendicular to the front face and the back face.

2. The alignment apparatus of claim 1, further comprising a second plate, the second plate having a front face, a back face, and an edge, wherein the second plate includes at least one fastener hole for receiving a fastening member and further includes at least one pin-receiving hole.

3. The alignment apparatus of claim 1, wherein the at least one pin is integrally or removeably attached to the first plate.

4. The alignment apparatus of claim 1, wherein the pin is cylindrical.

5. The alignment apparatus of claim 1, wherein the fastener member is selected from the group consisting of lags, lugs, or combinations thereof.

6. The alignment apparatus of claim 1, wherein the first plate is constructed from a material selected from the group consisting of steel, aluminum, stainless steel, or combinations thereof.

7. The alignment apparatus of claim 2, wherein the second plate is constructed from a material selected from the group consisting of steel, aluminum, stainless steel, or combinations thereof.

8. An alignment apparatus for a modular or prefabricated structure comprising:
i. a first plate having a front face, a back face, and an edge, wherein the first plate includes at least one fastener hole for receiving a fastening member;
ii. at least one pin positioned axially through the first plate such that it is perpendicular to the front face and the back face; and
iii. a second plate having a front face, a back face, and an edge, wherein the second plate includes at least one fastener hole for receiving a fastening member and further includes at least one pin-receiving hole.

9. An alignment apparatus for a modular or prefabricated structure comprising a first plate having a front face, a back face, and an edge, wherein the first plate includes at least one pin attached to the first plate such that it is perpendicular to the front face.

10. The alignment apparatus of claim 9, wherein the first plate is further comprised of at least one fastener hole for receiving a fastening member.

11. A method of using an alignment apparatus for a modular or prefabricated structure, the method comprising the steps of:
i. fastening a first plate to a first module, wherein the first plate is comprised of a front face, a back face, and an edge, and wherein the first plate further includes at least one fastener hole for receiving a fastening member and at least one pin positioned axially through the first plate such that it is perpendicular to the front face and the back face, which pin is inserted into at least one hole drilled into the first module;
ii. drilling at least one hole in a second module to receive the pin of the first plate;
iii. moving the first module and the second module together; and
iv. aligning the pin of the first plate with the hole of the second module.

12. The method of claim 10, further comprising the step of fastening a second plate to the second module, wherein the second plate is comprised of a front face, a back face, and an edge, and second plate further includes at least one fastener hole for receiving a fastening member and at least one pin-receiving hole.

13. The method of claim 11, wherein the pin-receiving hole of the second plate surrounds the hole drilled into the second module.

14. The method of claim 11, further comprising the step of aligning the pin of the first plate with the pin-receiving hole of the second plate.

15. A method of using an alignment apparatus for a modular or prefabricated structure, the method comprising the steps of:
i. fastening a first plate to a first module, wherein the first plate is comprised of a front face, a back face, and an edge, and wherein the first plate further includes at least one fastener hole for receiving a fastening member and at least one pin connected to the front face and the back face of the first plate such that it is perpendicular to the front face and the back face, which pin is inserted into at least one hole drilled into the first module;
ii. drilling at least one hole in a second module to receive the pin of the first plate;
iii. fastening a second plate to a second structure, wherein the second plate is comprised of a front face, a back face, and an edge, and wherein the second plate further includes at least one fastener hole for receiving a fastening member and at least one pin-receiving hole, which pin-receiving hole surrounds the hole drilled into the second module;
iv. moving the first module and the second module together; and
v. aligning the pin of the first plate with the pin-receiving hole of the second plate.
